(19) United States
(12) Patent Application Publication
(10) Pub. No.: US 2020/0238663 A1
(43) Pub. Date: Jul. 30, 2020

(54) COMPOSITE GLASS PANE HAVING CHAMFERED THROUGH-HOLE

(71) Applicant: SAINT-GOBAIN GLASS FRANCE, Courbevoie (FR)

(72) Inventors: Henrik WESSBERG, Ballingslöv (SE); Stefan UEBELACKER, Aachen (DE); Florence JACQUES, Aachen (DE); Alexandra YATIM, Aachen (DE)

(21) Appl. No.: 16/753,633

(22) PCT Filed: Sep. 17, 2018
(86) PCT No.: PCT/EP2018/074998

§ 371 Date: Apr. 3, 2020

(30) Foreign Application Priority Data
Oct. 4, 2017 (EP) 17194767.4

(51) Int. Cl. B32B 17/10

(52) U.S. Cl. CPC B32B 17/10036; B32B 17/10761; B32B 17/10293; B32B 2605/006; B32B 17/10788; B32B 2315/08; B32B 17/1077

(57) ABSTRACT

A composite glass pane with at least one through-hole, includes a first pane, a second pane, and at least one polymer intermediate layer between the first and second pane, wherein the through-hole is formed by a hole in the first pane, a hole in the polymer intermediate layer, and a hole in the second pane, wherein the hole in the first pane is a chamfered hole having a chamfer in each case on both sides of the first pane, and the hole in the second pane is a chamfered hole having a chamfer in each case on both sides of the second pane.

The invention relates to a composite glass pane, a method for producing the composite glass pane, and its use, in particular as a motor vehicle window.

Composite glass panes consist of at least one first pane or outer pane, one second pane or inner pane, and one polymer intermediate layer that joins the outer pane to the inner pane. Composite glass panes are used, for example, as vehicle windows or window panes for buildings. Composite glass panes can be used as flat or curved composite glass panes.

Depending on the intended use, it can be necessary for the glass to have at least one through-hole, e.g., to attach the composite glass pane to a mounting device, e.g., a side window in a vehicle, or to attach an attachment element, e.g., an antenna, on the composite glass pane. Composite glass panes that have through-holes re known. Some prior art examples are listed below.

WO 2005/040537 A1 describes a method for producing a composite glass pane having a through-hole comprising two panes and a joining intermediate layer, wherein a sealing element is arranged between the panes and around the through-hole to seal the through-hole against the intermediate layer.

U.S. Pat. No. 4,124,367 relates to a method for producing a curved composite glass windshield having at least one through-hole.

DE 19710824 C1 describes a fastening element for a composite glass pane, wherein the inner and outer pane are provided in each case with a different penetration, wherein the penetrations serve for attaching the holding element.

DE 69400415 T2 relates to a composite glass pane having a through-hole to accommodate a screw connection penetrating the composite glass pane.

DE 10 2006 056 501 A1 describes a composite glass pane having a through-hole, into which a fastening device for objects such as antennas can be inserted.

JP H07-186023 A describes a tool for chamfering a hole in a laminated glass formed from two glass panes and a polyvinyl butyral film positioned therebetween for a vehicle, wherein the upper and lower edge of each glass pane are provided with chamfers.

US 2006/134377 relates to a system for assembling two glass panes, each of which has a hole with conical regions on the opposite sides and which are connected via a clamping system engaging the holes. A gap remaining between the two glass panes is, for example, filled with a PVB film.

U.S. Pat. No. 4,124,367 A describes a method for producing a laminated curved composite glass with a hole near the edge for accommodating a windshield wiper, in which two curved glass panes and a plastic film positioned therebetween, each having a hole, are arranged such that the holes coincide, and the arrangement is laminated.

To form the through-holes in the composite glass panes, holes are drilled in the panes of the composite glass pane, with the holes often having to be positioned relatively close to the edge of the pane. Consequently, the panes and composite glass panes formed therefrom become fragile, in particular in the region of the hole.

As a result, a high proportion of the glass panes break during the production process of the composite glass pane having a through-hole and become unusable. In particular, when the panes for curved composite glass panes are bent in a furnace, the percentage of broken panes is high. In particular, in the case of industrial processes, this is, of course, quite unsatisfactory both economically and ecologically. While in use, wherein devices are usually mounted at the through-holes, the composite glass panes are exposed to increased stresses, in particular in the region of the through-holes, which can also result in cracks or breakage. Often, the installation of devices such as mounting fixtures at or in the through-holes is also not easy, possibly resulting in a loss of time.

The object of the invention is to eliminate or at least to reduce the above described disadvantages of the prior art. In particular, the object of the invention is to provide a composite glass pane having through-holes that is more robust against breakage and cracking compared to conventional composite glass panes having through-holes and during manufacture of which the percentage of broken panes or composite glass panes is reduced. The panes and composite glass should be given greater robustness.

The object is accomplished according to the invention by a composite glass pane according to claim 1. Additional embodiments of the invention relate to a method for producing the composite glass pane according to the invention and its use in accordance with the other independent claims. Preferred embodiments of the invention are apparent from the dependent claims.

With the composite glass pane according to the invention, composite glass panes having at least one through-hole can be provided, during the manufacture or assembly of which the percentage of broken and thus unusable panes is significantly reduced compared to the percentage during the manufacture or assembly of conventional composite glass panes with through-holes without a chamfer, in particular during the manufacturing step in which the panes are bent in a furnace. Compared to composite glass panes with a conventional through-hole, the composite glass pane according to the invention is also likely to show improved robustness in use in which the devices such as mounting devices or attachment elements are fastened at the through-hole. As a result of the chamfers, increased robustness in the panes and the composite glass pane formed therefrom is achieved overall.

A further advantage consists in that the installation of a device such as a holding device or an attachment element at the through-hole of the composite glass pane is easier.

Accordingly, the invention relates to a composite glass pane having at least one through-hole, comprising a first pane, a second pane, and at least one polymer intermediate layer between the first and second pane, wherein the through-hole is formed by a hole in the first pane, a hole in the polymer intermediate layer, and a hole in the second pane, wherein the hole in the first pane is a chamfered hole that has a chamfer on both sides of the first pane in each case, and the hole in the second pane is a chamfered hole that has a chamfer on both sides of the second pane in each case.

The composite glass pane is, in particular, a laminate in which the first and second pane are joined to one another by means of the at least one polymer intermediate layer by lamination.

The terms “hole” and “through-hole” have the same meaning here and refer to a hole that passes through from one side of the component having the hole to the other side of the component having the hole. To distinguish it from the holes in the individual components, the hole in in the composite glass pane is referred to here as a “through-hole”, unless otherwise indicated.

The composite glass pane according to the invention with at least one through-hole includes or or consists of a first pane with at least one hole, a second pane with at least one hole, and at least one polymer intermediate layer with at least one hole, which is arranged between the first and the second pane. Said holes in the first pane, the second pane, and the polymer intermediate layer are positioned such that in the composite glass pane, they are situated one above another and form the through-hole of the composite glass pane. Said holes in the first pane, the second pane, and the polymer intermediate layer are preferably positioned such that their centers are situated on or substantially on the central axis of the through-hole of the composite glass pane.

The at least one hole of the first pane and the at least one hole of the second pane, which, together with the at least one hole of the polymer intermediate layer, form the through-hole, can have a different size, but preferably have the same size or substantially the same size. If they have a different size, the following data concerning the diameter of the through-hole refers to the diameter of the hole of the pane that is smaller than the hole of the other pane.

The hole of the at least one polymer intermediate layer or polymer film, which, together with the holes of the first pane and the second pane, forms the through-hole, can have the same size or substantially the same size as the hole of the first pane and/or the hole of the second pane. However, it can optionally be expedient for the hole of the at least one polymer intermediate layer or polymer film to be larger than the holes of the first and second pane. This can be advantageous for preventing material from the intermediate layer melting during lamination from oozing into the through-hole. The data concerning the size of the at least one polymer intermediate layer refer in this case to the state of the polymer intermediate layer or polymer film before lamination.

The at least one through-hole is preferably circular. The advantage of circular through-holes resides in simple production and lower sensitivity to damage. Furthermore, most mounting systems or attachment parts intended for them are designed for circular through-holes. However, in individual cases, the at least one through-hole can also have a different shape, e.g., elliptical or irregular. It is understood that the shape of the holes in the first and second pane and also, in general, the shape of the hole in the at least one polymer intermediate layer usually corresponds to the shape of the through-hole. Consequently, the at least one chamfered hole in the first pane, the at least one chamfered hole in the second pane, and usually also the at least one hole in the at least one polymer intermediate layer are also preferably circular.

Preferably, the at least one through-hole has a diameter in the range from 5 to 100 mm, more preferably from 10 to 30 mm. If there are two or more through-holes, they can have a different or preferably the same diameter. It is understood that these data refer to circular through-holes. Non-circular through-holes preferably have a surface area that corresponds to a surface area of a circular through-hole with the aforementioned diameters. Here, the diameter and the circumference of the through-hole does not include the chamfered edge, in other words, the region of the chamfer is not included.

The shortest distance k from an edge of the composite glass pane to the perimeter of the at least one through-hole can, for example, be at least 5 mm, preferably at least 10 mm, and/or can, for example, be at most 40 mm, preferably at most 35 mm.

The composite glass pane according to the invention is in particular characterized in that the hole in the first pane and the hole in the second pane, which, together with the hole in the at least one polymer intermediate layer, form the through-hole, are in each case a chamfered hole. The following data and explanations for the chamfered hole apply equally, independently of one another, to the chamfered hole in the first pane and to the chamfered hole in the second pane.

A chamfered hole is a hole that has a chamfer, in other words, a sloped surface at the edge of the hole. The production of the chamfer is referred to as “chamfering”. The chamfer of the chamfered hole is preferably situated continuously around the entire circumference of the hole.

The chamfered hole of the first pane has a chamfer on both sides of the first pane, in other words, the chamfered hole has two chamfers, with, when incorporated into the composite pane, a chamfer on the side in the direction of the external environment and a chamfer on the side in the direction of the polymer intermediate layer. Similarly, the chamfered hole of the second pane has a chamfer on both sides of the second pane.

The geometry of the chamfers of the first and second pane in terms of chamfer angle α and chamfer height h can be within the usual ranges. Each individual one of these parameters can be the same or different for the chamfers of the chamfered holes of the first and second pane.

The chamfers can, for example, have an angle α in the range from 35° to 55°.

The chamfers can, for example, have a height h in the range from 0.1 to 1 mm, preferably 0.3 to 0.8 mm. With regard to tolerances, the chamfer height is preferably 0.3±0.2 mm to 0.8 mm±0.2mm.

So-called “shell chipping” refers to a defect that can occur at the edge of chamfers. The size of shell chipping should preferably be as small as possible and, optimally, there should be no shell chipping at all. The size of shell chipping at the edge of the chamfers is, if present, preferably less than 1000 microns (μm), more preferably less than 500 μm.

The composite glass pane can have one or a plurality of through-holes of the type mentioned. It is understood that when there is more than one such through-hole, the first pane, the second pane, and the at least one polymer layer have in each case correspondingly more than one hole and the above data apply correspondingly in the same way to each additional through-hole.

The composite glass pane can, for example, have one, two, three, four, or more through-holes, with each through-hole formed in each case by a chamfered hole in the first pane, a hole in the at least one polymer intermediate layer, and a chamfered hole in the second pane. The composite glass pane preferably has 1 or 2 through-holes.

The first pane and the second pane can have the same thickness or different thicknesses. Preferably, the first pane and the second pane have, independently of one another, a thickness in the range from 0.3 to 10 mm, preferably 0.5 to 5 mm. The first pane and the second pane usually form the outer sides of the composite glass pane. Optionally, they can be provided with an external coating.

The first pane and the second pane can be made of the same material or of a different material. The panes are glass panes and can, for example, be formed from inorganic glass and/or organic glass, i.e., organic polymers. In a preferred embodiment, the first pane and/or the second pane are formed from flat glass, quartz glass, borosilicate glass, soda lime glass, alkali aluminosilicate glass, polycarbonate, and/or polymethacrylate. The first pane and/or the second pane are preferably made of flat glass.

The first and the second pane can be formed from non-tempered glass, thermally or chemically partially tempered glass (TVG) or thermally or chemically tempered glass (ESG). Machining partially tempered and tempered glass is difficult. Consequently, processing steps such as cutting the panes to size and providing the panes with a hole and chamfering are usually carried out before the tempering or partial tempering process. The glass can also be enameled glass. Enameled glass is, for example, a thermally tempered glass in which a colored enamel layer has been fired, e.g., during the tempering process.

In a preferred embodiment, the first pane and/or the second pane is made of partially tempered glass, preferably thermally partially tempered glass. Most particularly preferably, the first pane and the second pane are made of partially tempered glass. When using partially tempered glass, the aforementioned advantage in terms of reduced breakage during the production process and in use is particularly pronounced.

The edge compressive stress at the through-hole is, among other things, a function of the thickness of the glass and the tempering. The edge compressive stress is preferably greater than 10 MPa, more preferably greater than 15 MPa. The edge tensile stress is preferably greater than 4 MPa.

The surface compressive stress of the first pane and the surface compressive stress of the second pane is preferably greater than 20 MPa, preferably greater than 30 MPa.

Edge compressive stress, edge tensile stress, and surface compressive stress are determined on the composite glass pane. The edge compressive stress is measured using an edge compressive stress meter (e.g., Sharples). The surface compressive stress is measured using a surface compressive stress meter. As is known to the person skilled in the art, the selection of the appropriate measuring instrument depends on whether the glass is clear, tinted, cloudy, or enameled.

For example, for a clear composite glass pane without screen printing, the edge compressive stress is measured using Sharples. This is a “transmission technique” meter from the company Sharples Stress Engineer Ltd. based on the Senarmont principle. The device is oriented at a right angle to the edge of the point to be measured. To measure the edge compressive stress, the compensator rotation dial is turned until the middle of the dark line reaches the glass edge (ground edge). The rotation angle is a measure of the edge compressive stress.

The surface compressive stress can, for example, be measured by the SCALP 05 measuring instrument from the company GlasStress Ltd. The instrument is placed, together with a contact liquid, on the point to be measured. For a composite glass pane such as a side window pane, a five-point measurement is advisable (one central and each edge). The average is formed from the individual measurements determined. The principle of measurement by the instrument can be described as follows. During measurement, the polarization of the laser beam is optically modulated by the stress-induced birefringence in the glass and by the modulator in the SCALP. The modulated laser light is scattered on the glass particles (elastic Rayleigh scattering), wherein the intensity of the scattered light is a function of the polarization status of the laser beam. During the measurement, the SCALP instrument records the variations of the scattered light intensity along the laser beam. From this information, the absolute optical delay at any point along the laser beam can be calculated. The stress is calculated before the increase of the optical delay.

The at least one polymer intermediate layer has at least one hole, which serves to form the at least one through-hole.

The at least one polymer intermediate layer is preferably a thermoplastic intermediate layer. Usually, one or a plurality of polymer films are used to form the at least one polymer intermediate layer. The at least one polymer intermediate layer or polymer film serves as a laminating layer, i.e., for joining or laminating the first pane, the second pane, and, optionally, additional intermediate layers by adhesive bonding.

The at least one polymer intermediate layer can be formed, for example, by one or a plurality of polymer films, e.g., 1, 2, or 3 polymer films, in particular thermoplastic polymer films. Such thermoplastic layers or thermoplastic polymer films are well-known to the person skilled in the art and are commercially available.

The polymer intermediate layer or the polymer film, e.g., a PVB film, has, for example, a thickness of 0.1 to 2 mm and more preferably of 0.3 to 1 mm, typically 0.38 mm or 0.76 mm or 0.81 mm. The thickness data refer, in each case, to one polymer intermediate layer or one polymer film.

The polymer of the at least one polymer intermediate layer or polymer film contains or is, for example, polyvinyl butyral (PVB), ethylene vinyl acetate (EVA), polyurethane, a copolymer thereof, a derivative thereof, or mixtures thereof, with PVB films or layers formed from PVB particularly preferred. In addition to the polymer, in particular the thermoplastic polymer, the polymer intermediate layer can, optionally, contain customary additives, such as plasticizers or fillers.

In addition to the at least one polymer intermediate layer or polymer film, which serves for lamination, the composite glass pane can optionally contain, as functional layers, one or a plurality of additional polymer layers, which are likewise arranged between the first and second pane, e.g., an infrared reflecting polymer film, e.g., a polyester film, which optionally has a coating, e.g., of silver, with such a layer or film preferably arranged between two of the aforementioned polymer intermediate layers. It is understood that when such additional polymer layers are contained as functional layers, these also have at least one hole for forming the through-hole.

The first pane, the second pane, and/or the at least one polymer intermediate layer can be clear and colorless, but also tinted, cloudy, or colored.

The composite glass pane according to the invention can be flat or curved in one or more spatial directions. The composite glass pane according to the invention is preferably a curved composite glass pane. In the case of a curved composite glass pane, the first pane and the second pane are preferably provided with the through-hole(s) before being bent. The composite pane can, however, also be flat, e.g., when is intended for buses, trains, or tractors.

The composite glass pane is preferably a vehicle pane, preferably a motor vehicle window, in particular a pane of a passenger car, which are typically curved. In an advantageous embodiment, the composite glass pane according to the invention is a side window, in particular an openable side window, of a motor vehicle, in particular of a passenger car.

The at least one through-hole can be used for installing a mounting device or for installing an attachment part, such as an antenna. The mounting device can be a fastening device engaging in the through-hole(s) for installing the composite glass pane on the vehicle.

The invention also relates to the use of the composite glass pane according to the invention as a window pane for structures, in particular buildings, or in particular as a vehicle window, preferably a motor vehicle window. The vehicle can be a land, water, or air vehicle and is preferably a motor vehicle, particularly preferably a passenger car. Use as a side window of the vehicle, in particular for openable side windows is preferred, especially for a passenger car.

The invention further relates to a method for producing a composite glass pane according to the invention, comprising the following steps:
a) providing a first pane with at least one chamfered hole, which has, in each case, a chamfer on both sides of the pane, a second pane with at least one chamfered hole, which has, in each case, a chamfer on both sides of the pane, and at least one polymer intermediate layer with at least one hole,
b) arranging the at least one polymer intermediate layer between the first pane and the second pane, wherein the at least one chamfered hole of the first pane, the at least one chamfered hole of the second pane, and the hole of the at least one polymer intermediate layer are positioned such that they form at least one through-hole in the assembly formed; and
c) bonding the first pane to the second pane by lamination using the at least one polymer intermediate layer.

One or a plurality of polymer films are usually used to form the at least one polymer intermediate layer. The invention thus also relates to a method for producing a composite glass pane according to the invention, comprising the following steps:
a) providing a first pane with at least one chamfered hole, which has, in each case, a chamfer on both sides of the pane, a second pane with at least one chamfered hole, which has, in each case, a chamfer on both sides of the pane, and at least one polymer film with at least one hole,
b) arranging the at least one polymer film between the first pane and the second pane, wherein the at least one chamfered hole of the first pane, the at least one chamfered hole of the second pane, and the hole of the at least one polymer film are positioned such that they form at least one through-hole in the assembly formed; and
c) bonding the first pane to the second pane by lamination using the at least one polymer film.

To form the at least one chamfered hole in the first and second pane, the first and the second pane are provided with the desired number of holes, e.g., by hole drilling, with hole drilling using tools provided with diamonds customary. The holes of the first and second pane are then chamfered in the usual manner, e.g., with a common countersinking tool, to form the chamfer. Care should be taken during drilling and chamfering to keep defects such as shell chipping as small as possible.

If tempered or partially tempered glass is used for the first pane and/or the second pane, the panes are usually provided with the chamfered holes before the panes are subjected to the tempering or partial tempering process.

The at least one hole in the at least one polymer intermediate layer or the polymer film used for it can, for example, be produced by cutting or punching.

If the composite glass is to be bent, the first pane and the second pane are preferably bent before lamination, with all standard bending methods being suitable. Bending preferably takes place only after creation of the holes in the individual panes since flat panes are more easily provided with holes.

Typically, the first and second pane can be bent, for example, by gravity bending methods. The flat panes are placed on a mold with the desired geometry and slowly heated in a furnace to near the softening temperature or to the softening temperature, as a result of which the pane drops into the mold by gravity. Preferably, the first and second pane arranged one atop the other are subjected to gravity bending together, with a separating means usually provided between the two panes.

After the arrangement of the components, the first pane is joined by lamination to the second pane by means of the at least one polymer film. The lamination for forming the composite can be carried out by customary methods, for example, by vacuum bag methods, vacuum ring methods, calender methods, vacuum laminators, autoclave methods, or combinations thereof. The joining of the first and the second pane by means of the the at least one polymer film is customarily done under the influence of heat, vacuum, and/or pressure.

The above-described preferred embodiments of the composite glass pane also apply accordingly to the method.

The invention is explained in detail in the following based on nonrestrictive exemplary embodiments with reference to the accompanying drawings.

They depict:

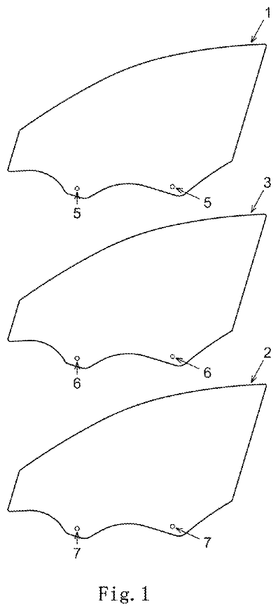

FIG. 1 a first pane 1 with two chamfered holes 5, a second pane 2 with two chamfered holes 7, and a polymer intermediate layer 3 with two holes 6;

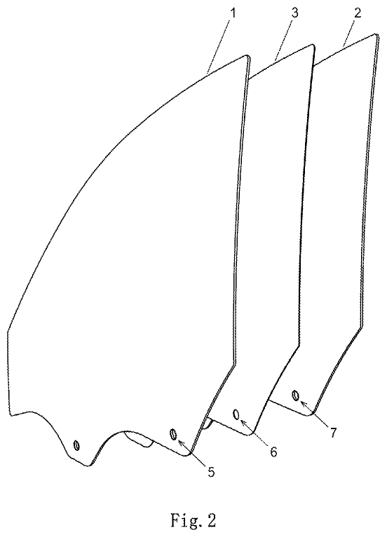

FIG. 2 an exploded view of an embodiment of a composite glass pane according to the invention formed from the components depicted in FIG. 1;

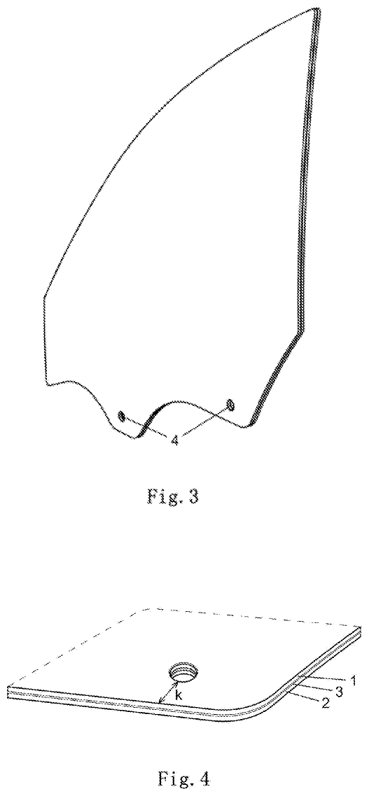

FIG. 3 the composite glass pane according to the invention of FIG. 2 with two through-holes 4;

FIG. 4 a perspective detail of the composite glass pane of Fig.2, showing a through-hole 4 and its shortest distance to the edge of the composite glass pane zeigt;

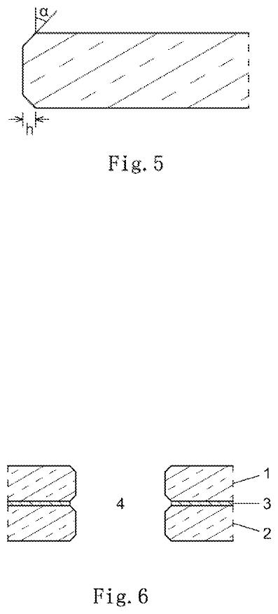

FIG. 5 schematically, a detail of a chamfered hole of a pane (first pane or second pane) in cross-section, wherein only one side of the hole is depicted. The chamfered hole has, in each case, a chamfer on both sides of the pane (upper and lower side of the pane). The principle sketch shows the chamfer angle α (for the upper chamfer) and the chamfer height h (for the lower chamfer).

FIG. 6 a side view of the through-hole 4 of the composite glass pane according to the invention, wherein both the chamfered hole 5 of the first pane 1 and the chamfered hole 7 of the second pane 2 have, in each case, two chamfers, one in the direction of the surroundings and one in the direction of the polymer intermediate layer 3.

It is understood that the specific shape of the composite glass pane depicted in the figures is only for illustration and that the invention is not restricted to the shapes shown.

### EXAMPLE

A pane, as schematically depicted in FIG. 1-6, was produced. A curved pane was produced (not shown in the figures). The curved composite glass pane formed had the following characteristics:

First pane: partially tempered glass with a thickness of 2.1 mm,

Polymer film: PVB film with a thickness of 0.76 mm,

Second pane: partially tempered glass with a thickness of 1.6 mm,

Through-holes: Number: 2, Diameter: 14.5 mm, Shortest distance to the pane edge: 21.75 mm
Chamfer parameters: Chamfer angle in each case 45°, Chamfer height in each case 0.5 mm.

The not yet partially tempered first pane and second pane were provided with the chamfered holes. Then, the first and second pane were bent together into the desired shape by gravity bending. The panes were then subjected to a thermal tempering process.

Then, the panes were stacked with PVB film into which the suitable holes were punched. The pair of panes with interposed PVB film is then pre-bonded, for example, by a calendar roll or other deaeration method and then finally bonded in the autoclave by autoclaving.

By means of the present invention, in which panes having chamfered holes are used, it is possible to reduce the percentage of breakage during production of the composite glass pane compared to the production of a similar composite glass pane with a conventional through-hole without chamfers by as much as 20-50%.

### LIST OF REFERENCE CHARACTERS

1 first pane
2 second pane
3 polymer intermediate layer or film
4 through-hole
5 chamfered hole of the first pane
6 hole of the polymer intermediate layer or film
7 chamfered hole of the second pane
α chamfer angle
h chamfer height
k shortest distance from the composite glass pane edge to the perimeter of the through-hole

1. A composite glass pane with at least one through-hole, comprising a first pane, a second pane, and at least one polymer intermediate layer between the first and second pane, wherein the through-hole is formed by a hole in the first pane, a hole in the polymer intermediate layer, and a hole in the second pane, wherein the hole in the first pane is a chamfered hole having a chamfer in each case on both sides of the first pane, and the hole in the second pane is a chamfered hole having a chamfer in each case on both sides of the second pane.

2. The composite glass pane according to claim 1, wherein the chamfers have an angle α in the range from 35° to 55°.

3. The composite glass pane according to claim 1, wherein the chamfers have a height h in the range from 0.1 to 1 mm.

4. The composite glass pane according to claim 1, wherein the first pane and the second pane are made of partially tempered glass.

5. The composite glass pane according to claim 1, wherein the edge compressive stress at the through-hole is greater than 10 MPa.

6. The composite glass pane according to claim 1, wherein the surface compressive stress of the first pane and the surface compressive stress of the second pane is greater than 20 MPa.

7. The composite glass pane according to claim 1, wherein the size of shell chipping, if present, at the edge of the chamfers is less than 1000 μm.

8. The composite glass pane according to claim 1, wherein the shortest distance k from an edge of the composite glass pane to the perimeter of the at least one through-hole is at least 5 mm and/or at most 40 mm.

9. The composite glass pane according to claim 1, wherein the at least one through-hole has a diameter in the range from 5 to 100 mm.

10. The composite glass pane according to claim 1, wherein the first pane and/or the second pane have, independently of one another, a thickness in the range from 0.3 to 10 mm.

11. The composite glass pane according to claim 1, wherein the first pane and/or the second pane is made of inorganic glass and/or organic glass.

12. The composite glass pane according to claim 1, wherein the at least one through-hole is one, two, three, or four through-holes, wherein each through-hole is formed in each case by a chamfered hole in the first pane, a hole in the at least one polymer intermediate layer, and a chamfered hole in the second pane.

13. The composite glass pane according to claim 1, wherein the composite glass pane is a curved composite glass pane.

14. A method comprising utilizing a composite glass pane according to claim 1 as a window pane for buildings or as a vehicle window.

15. A method for producing a composite glass pane according to claim 1, comprising:
a) providing a first pane having at least one chamfered hole that has a chamfer in each case on both sides of the pane, a second pane with at least one chamfered hole that has a chamfer in each case on both sides of the pane, and at least one polymer intermediate layer with at least one hole,
b) arranging the at least one polymer intermediate layer between the first pane and the second pane, wherein the at least one chamfered hole of the first pane, the at least one chamfered hole of the second pane, and the hole of the at least one polymer intermediate layer are positioned such that they form at least one through-hole in the assembly formed; and
c) joining the first pane to the second pane by means of the at least one polymer intermediate layer by lamination.

16. The composite glass pane according to claim 3, wherein the chamfers have a height h in the range from 0.3 to 0.8 mm.

17. The composite glass pane according to claim 5, wherein the edge compressive stress at the through-hole is greater than 20 MPa.

18. The composite glass pane according to claim 6, wherein the surface compressive stress of the first pane and the surface compressive stress of the second pane is greater than 30 MPa.

19. The composite glass pane according to claim 7, wherein the size of shell chipping, if present, at the edge of the chamfers is less than 500 μm.

20. The composite glass pane according to claim 9, wherein the at least one through-hole has a diameter in the range from 10 to 30 mm.
